(19) United States
(12) Patent Application Publication
(10) Pub. No.: US 2012/0130604 A1
(43) Pub. Date: May 24, 2012

(54) AUTOMATIC SHUTDOWN SYSTEM FOR AUTOMOBILES

(76) Inventors: Michael W. Kirshon, Delray Beach, FL (US); Barry Kupferberg, Boca Raton, FL (US); Martin Schneider, Cabedelo (BR)

(21) Appl. No.: 13/301,673

(22) Filed: Nov. 21, 2011

Related U.S. Application Data
(60) Provisional application No. 61/417,058, filed on Nov. 24, 2010.

(51) Int. Cl. F02D 17/02; G06F 7/00

(52) U.S. Cl. 701/51; 701/102

(57) ABSTRACT

A vehicle status monitor and control system monitors a series of sensors installed within a vehicle to monitor specific functions to determine if a vehicle engine is running and there is a potential for toxic exhaust gases to accumulate, creating a toxic environment. The vehicle status monitor and control system determines if the vehicle is running and stationary over a predetermined period of time. The system additionally monitors the presence of a driver. If the predetermined conditions are met, the system terminates the operation of the vehicle's engine. The system can optionally include an override feature to ensure the engine continues running when desired.

### CROSS-REFERENCE TO RELATED APPLICATION

This application claims priority to provisional application Ser. No. 61/417,058, filed on Nov. 24, 2010. the entire contents of which are hereby incorporated by reference.

### FEDERALLY SPONSORED RESEARCH OR DEVELOPMENT

Not Applicable

### BACKGROUND

1. Technical Field

The present disclosure generally relates to a monitor and control system and respective method for determining when an idling vehicle engine can be creating a toxic environment, and for automatically disabling the engine in response to such determination.

2. Background

Combustion engines discharge an exhaust that includes toxic gases, such as carbon monoxide. It is well known that elevated levels of carbon monoxide gases contained within a closed space can have harmful and even fatal effects on individuals exposed to higher concentrations thereof.

Numerous occurrences have been noted where residential occupants have succumbed to toxic exhaust gases discharged by a miming vehicle engine, where the vehicle was parked within an attached garage. Several advancements in vehicle technology are aggravating the potential issue. For example, keyless engine control systems allow an operator to leave the vehicle while the engine remains running. Until recently, all vehicle engines would initiate operation by inserting a key into an ignition switch, whereby removing the key causes the engine to cease operating. The vehicle key would commonly be stored on a key ring used to hold a series of keys. The operator commonly uses other keys to access buildings, offices, desks, residence, etc. An operator who forgets to remove the keys from the vehicle would be reminded the next time a key stored on the same key ring would be needed. Furthermore, vehicle engines are now much quieter, making people less aware that the engine is running. In addition, vehicles now commonly include remote starters, where an individual can start a vehicle's engine remotely. This can occur by accidentally depressing the remote start button, thereby starting the vehicle engine unbeknownst to the individual.

A known solution integrates a carbon monoxide sensor into the vehicle. The carbon monoxide sensor may be located either within the vehicle or somewhere on the exterior of the vehicle. A monitoring system monitors the carbon monoxide sensor(s) and disables the engine when the sensor indicates an undesirable condition. This technology requires the integration of the carbon monoxide sensors, which introduces additional components, cost, and maintenance. Additionally, the technology relies upon the sensors to operate correctly. The sensor needs to be monitored to ensure that the sensor is properly working. Externally located sensors are exposed to the operational conditions of the vehicle, such as being subjected to moisture, heat, cold, debris (such as dust, dirt, etc.). insects, etc. Each of these can alter the functionality of the carbon monoxide sensors.

While the aforementioned known art provides a reasonable solution for the basic purpose and function for which it has been specifically designed, the solution is deficient in its failure to provide a simple, efficient, low cost, practical, and reliable toxic gas concentration governing system that is tied into a vehicle ignition to cease the generation of the toxic exhaust gases when deemed necessary.

As a consequence of the above discussed situations, there has existed a longstanding need for a new and improved automotive toxic gas concentration governing system that monitors the vehicle for a condition where toxic gas gases may collect and determines whether to disable the ignition of the vehicle engine in response to a series of conditions.

Therefore, it would be advantageous to provide a monitor and control system that determines when an exhaust of an idling vehicle engine can be creating a toxic environment and that, subsequently, automatically disables or turns off the ignition of the vehicle engine to cease the generation of the toxic exhaust gases. It would be additionally advantageous for the monitor and control system to minimize the possibility of an inappropriate engine shutdown. i.e., a shutdown that is not the result of the detection of a toxic environment.

### SUMMARY

The various embodiments of the present automatic shutdown system for automobiles have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

The present disclosure is generally directed to a vehicle status monitor and control system and respective method of use for automatically disabling the ignition of the vehicle engine to cease the generation of the toxic exhaust gases.

One aspect of the present embodiments comprises a vehicle status monitor and control system configured to shut down an engine of a vehicle when a given set of conditions prevails. The system comprises a control unit including a controller in signal communication with a sensor interface; a plurality of status sensors in signal communication with the sensor interface; a time reference in signal communication with the controller; and an engine control unit in signal communication with the controller and in operational communication with a vehicle's engine ignition system. The controller operates in accordance with a series of steps directed by control system software to provide a signal to the engine control unit to disable the vehicle's engine ignition system when a predetermined system status prevails over a predetermined length of time T.

In a particular configuration, the controller operates in accordance with a series of steps directed by the control system software to provide a signal to the engine control unit to disable the vehicle's engine ignition system when one of a plurality of predetermined system statuses prevails for a predetermined length of time, as indicated by a status of each of the plurality of status sensors. The controller queries the system for available ones of the sensors, and directs the control system software to disable the vehicle's engine ignition system based upon inputs from only the available ones of the sensors.

Another aspect of this disclosure is a method of ensuring that a decision to shut down a vehicle engine is based upon current sensor data. The method comprises determining if sensor data from a plurality of sensors is current; obtaining current sensor data from a plurality of status sensors associated with the vehicle engine, if the sensor data is not current; parsing the current sensor data; comparing the parsed sensor data to an established suggested shutdown state with respect to each of the plurality of sensors; determining whether the parsed sensor data corresponds to the suggested shutdown state; and setting a shutdown flag, if the parsed sensor data corresponds to the suggested shutdown state.

In yet another aspect, the vehicle status monitor and control system further comprises a vehicle speed sensor in signal communication with the sensor interface, wherein the control system software additionally requires the vehicle speed sensor to indicate the vehicle is stationary over a predetermined period of time prior to providing a signal to the engine control unit to disable the vehicle's engine ignition system.

In yet another aspect, the vehicle status monitor and control system further comprises a transmission status sensor in signal communication with the sensor interface, wherein the control system software additionally requires the transmission status sensor to indicate that a transmission is in “park” over a predetermined period of time prior to providing a signal to the engine control unit to disable the vehicle's engine ignition system.

In yet another aspect, the vehicle status monitor and control system further comprises an accelerator pedal status sensor in signal communication with the sensor interface, wherein the control system software additionally requires the accelerator pedal sensor to indicate that the accelerator pedal is in an idle position over a predetermined period of time prior to providing a signal to the engine control unit to disable the vehicle's engine ignition system.

In yet another aspect, the vehicle status monitor and control system further comprises a parking brake status sensor in signal communication with the sensor interface, wherein the control system software additionally requires the parking brake sensor to indicate that the parking brake is in an engaged position over a predetermined period of time prior to providing a signal to the engine control unit to disable the vehicle's engine ignition system.

In yet another aspect, the vehicle status monitor and control system further comprises a carbon monoxide sensor provided in signal communication with the sensor interface.

In yet another aspect, the vehicle status monitor and control system further comprises learning software to update the software, modify the software, and establish or change settings, etc.

In yet another aspect, the plurality of sensors is connected to the sensor interface using a BUS interface.

In yet another aspect, the vehicle status monitor and control system further comprises an override option, wherein the override option notifies a vehicle operator of a pending shutdown condition, and allows a predetermined period of time for the operator to respond. Then, if an override is not indicated, the system provides a signal to the engine control unit to disable the vehicle's engine ignition system.

In yet another aspect, additional sensors can be monitoring to provide additional assurance to avoid a false engine shutdown.

These and other aspects, features, and advantages of the present invention will become more readily apparent from the attached drawings and the detailed description of the preferred embodiments, which follow.

### BRIEF DESCRIPTION OF THE DRAWINGS

The present embodiments now will be discussed in detail with an emphasis on highlighting the advantageous features. These embodiments depict the novel and non-obvious automatic shutdown system for automobiles shown in the accompanying drawings, which are for illustrative purposes only. These drawings include the following figures, in which like numerals indicate like parts:

FIG. 1 presents a schematic block diagram of an example automatic vehicle shut down system;

FIG. 2 presents a schematic block diagram of an enhanced example automatic vehicle shut down system;

FIG. 3 presents an example functional schematic of the enhanced example automatic vehicle shut down system of FIG. 2;

FIG. 4 presents an example automatic shutdown flow diagram;

FIG. 5 presents an example sensor data management flow diagram;

FIG. 6 presents a first example sensor state decision flow diagram for use in conjunction with an automatic transmission;

FIG. 7 presents a second example sensor state decision flow diagram for use in conjunction with a manual transmission; and

FIG. 8 presents an example operator override flow diagram.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features.

The drawings and their descriptions may indicate sizes, shapes and configurations of the various components. Such depictions and descriptions should not be interpreted as limiting. Alternative sizes, shapes and configurations are also contemplated as within the scope of the present embodiments. Also, the drawings, and their written descriptions, indicate that certain components of the apparatus are formed integrally, and certain other components are formed as separate pieces. Components shown and described herein as being formed integrally may in alternative embodiments be formed as separate pieces. Further, components shown and described herein as being formed as separate pieces may in alternative embodiments be formed integrally. As used herein the term “integral” describes a single unitary piece.

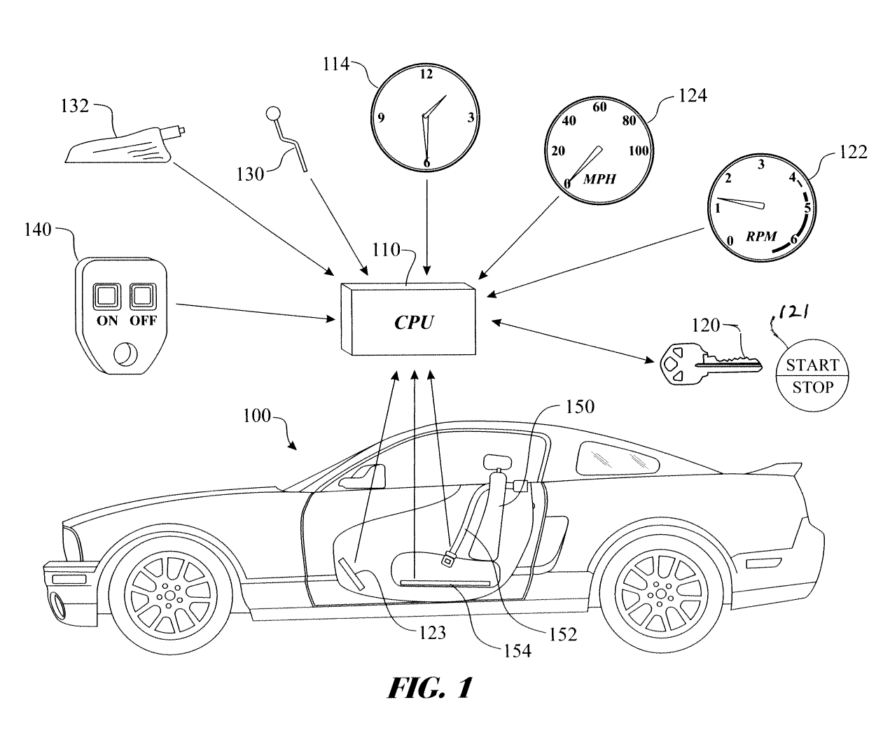

The following detailed description is merely exemplary in nature and is not intended to limit the described embodiments or the application and uses of the described embodiments. As used herein, the word “example” or “illustrative” means “serving as an example, instance, or illustration.” Any implementation described herein as “example” or “illustrative” is not necessarily to be construed as preferred or advantageous over other implementations. All of the implementations described below are example implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply example embodiments of the inventive concepts defined in the appended claims. Hence, specific dimensions and other physical characteristics relating to the embodiments disclosed herein are not to be considered as limiting, unless the claims expressly state otherwise.

The present embodiments provide systems and methods for disabling a vehicle engine when a potentially hazardous environment may be created in the vehicle's vicinity, such as by a buildup of poisonous gases. Another benefit of the present embodiments is conservation of fuel. When a condition exists where the vehicle may be causing an accumulation of toxic gases, the vehicle is also burning and wasting fuel. By terminating the operation of the engine, the present embodiments reduce excess fuel consumption.

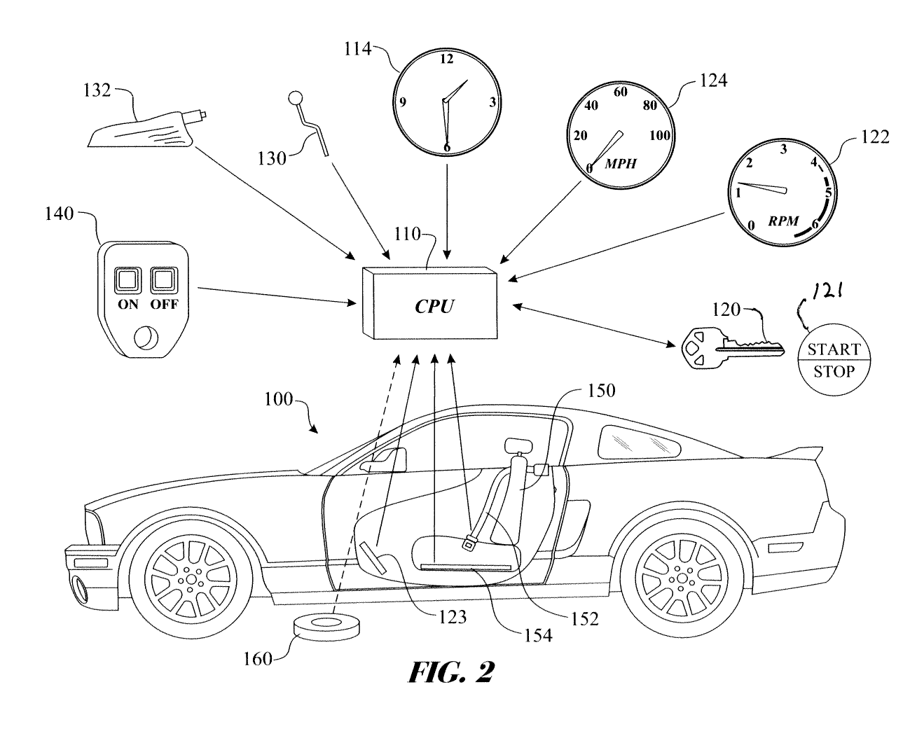

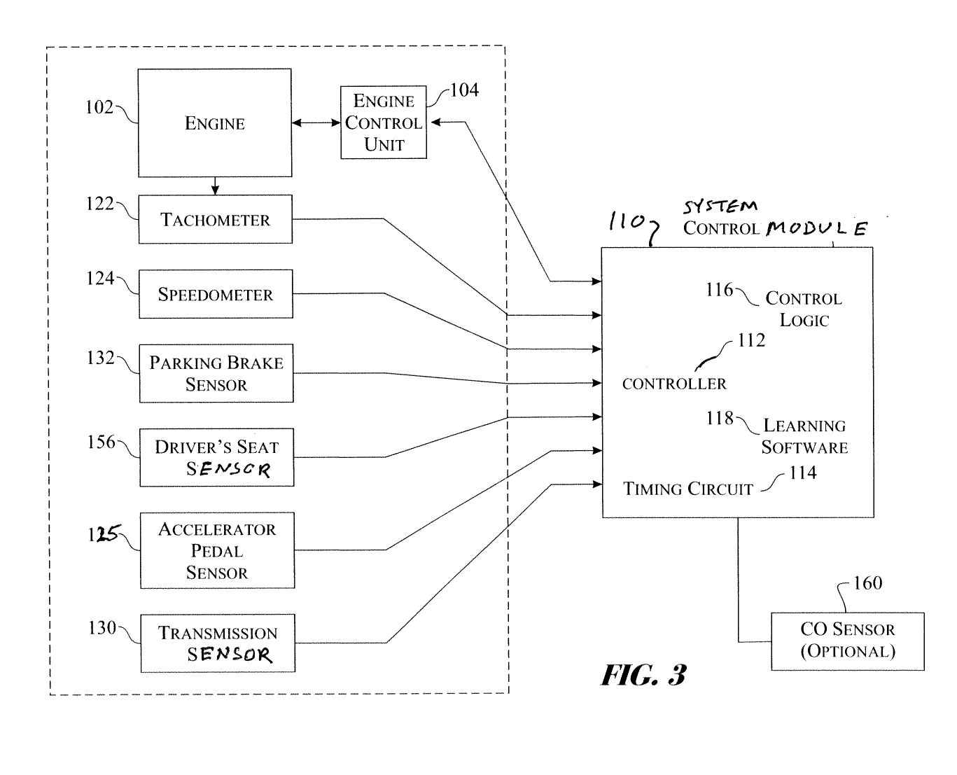

An example vehicle status monitor and control system integrates software with existing vehicle status sensing devices, with the various elements being illustrated in FIGS. 1 and 2. A functional block diagram of the example vehicle status monitor and control system is illustrated in FIG. 3. A vehicle 100 includes a vehicle engine 102, which is an internal combustion engine that discharges toxic exhaust gases when running. The toxic gases can accumulate within an enclosed environment in which the vehicle is located, creating a potentially hazardous environment for people and/or animals located therein. The present embodiments provide systems and methods for addressing this situation.

An ignition system of the vehicle is actuated by an actuation device, which may be a key 120 and/or an electronic start/stop button 121. The key 120 may be an electronic key that communicates with the vehicle with radio frequency (RF) signals, for example. With an electronic key, an operator may exit the vehicle with the key while the vehicle's engine remains running. Additionally, the operator may depress the start/stop button believing that the engine's operation has been terminated, but the engine may still be running. If the vehicle 100 is located in an enclosed environment, the exhaust accumulates, creating a hazardous environment.

A vehicle remote starter control 140 can be used to start the vehicle engine 102 remotely. The vehicle remote starter control 140 allows the operator to start the vehicle 100 remotely so that, for example, the engine may warm up and/or an interior temperature of the vehicle may be adjusted prior to driving. If the vehicle 100 is located in an enclosed environment when it is started remotely, the exhaust accumulates, creating a hazardous environment.

The vehicle status monitor and control system monitors various elements of the vehicle 100 to determine a potential risk of formation of a collection of toxic gases. With continued reference to FIG. 1, a system control module 110 is integrated into the vehicle 100 to provide the overall controlling function of the system. An existing on-board computer may be adapted to include operational software and provide the functionality of the system control module 110, thus eliminating any requirement for additional hardware, while using the existing integrated original equipment manufacturer (OEM) sensor communication infrastructure.

Various monitored elements are provided in signal communication with the system control module 110. With reference to FIG. 3, the state of each sensor or status indicator is then monitored by a system controller 112, which may be a microcontroller, for example. The system controller 112 determines whether the state of the monitored sensors suggests a condition exists that can cause an accumulation of toxic gases. When it is determined that a potential risk exists, the vehicle status monitor and control system uses a controller logic sub-module 116 within the system control module 110 to terminate operation of the engine. The controller logic sub-module 116 is employed to control any desired functions, such as terminating the operation of the vehicle engine 102. Learning software 118 can be included in the system control module 110, providing a means for adjusting the predetermined settings established for determining when the sensors suggest a potential hazard, the predetermined period of time that controls when to act to avoid the potential hazard, etc. The learning software 118 additionally allows the system to download software updates.

The system uses logic to determine if a condition exists that can cause an accumulation of toxic gases. For example, in one embodiment, the logic determines if the engine is running and the vehicle is stationary over a period of time T, and an operator is not operating the vehicle. Under those conditions, there is a considerable risk of toxic gases accumulating and creating an unsafe environment.

With reference to FIGS. 1 and 3, the engine 102 has an engine control unit 104 operatively connected to the ignition system 120 and the system control module 110. The engine 102 may have a sensor associated with it for monitoring a status of the engine 102. The vehicle 100 further includes a transmission, which is represented by and operated by a gearshift lever 130. The status of the vehicle engine 102 and gearshift lever 130 can indicate a stationary and idling condition.

The vehicle 100 commonly further comprises a parking brake 132. It is common, particularly for vehicles having a manual transmission, for the parking brake 132 to be engaged when the vehicle is parked. Thus, sensing a condition of the parking brake 132 provides an additional data point for determining if there is a potential danger of an accumulation of toxic gases. The ignition system 120 may include any component used to control the operation of the engine 102, such as, for example, an ignition switch (key operated, start/stop button. etc.), an ignition control module, a fuel flow controller, etc.

The vehicle 100 includes a series of operating status indicators that inform the operator of the operating conditions of the vehicle 100. These can include a tachometer 122, which informs the operator of the engine speed in revolutions per minute (RPMs), and a speedometer 124, which informs the operator of the vehicle's speed. Each of the tachometer 122 and the speedometer 124 may have a sensor associated with it for monitoring a status of the engine 102. The vehicle 100 further includes an accelerator pedal 123, and an accelerator pedal position sensor 125 for sensing a position of the accelerator pedal 123, which can provide an indication of engine speed, which can in turn provide an indication of vehicle speed. Other engine speed sensors and/or processes can be used in addition to, or in place of the foregoing sensors and/or processes, including an engine idle sensor, an ignition timing sensor, etc. These operating status indicators provide additional data points conveyed to the system control module 110 and can be used for determining the potential risk of accumulation of toxic gases.

Another indicator of a potentially harmful condition is the status of the vehicle operator or driver. If the vehicle engine 102 is running and an operator is not sitting in the driver's seat 150, it is likely that the vehicle 100 is parked, and may be creating a hazardous environment. Whether or not the operator is present may be determined by monitoring a driver's seat status sensor 156 operatively associated with the driver's seat 150 The driver's seat status sensor 156 may be any of a variety of sensors integrated into or operatively connected to the driver's seat 150, including a monitor for the driver's seat belt 152, a driver's seat weight sensor 154, etc. Sensors of these types may be standard or optional equipment in modern vehicles.

A system timer 114 can be integrated into the system in any of a variety of means. The system timer 114 may be integrated into the system control module 110, or it may be provided remotely (such as a vehicle clock) and placed in signal communication with the system control module 110 using any signal communication interface. The system control module 110 uses the system timer 114 for determining a span of time associated with a status being monitored.

In certain embodiments, the system may include a toxic gas sensor 160. The toxic gas sensor 160 is placed in signal communication with the system control module 110. The preferred embodiment monitors the toxic gas sensor 160 is employed in parallel with the sensor logic described above to determine a potential for creating an unsafe environmental condition. The system control module 110 can alternatively use sensor logic to determine whether the vehicle is running or whether it is stationary. If it is stationary for a period of time T (determined by the timing circuit 114), the system will disengage the ignition of the vehicle engine 102, or interpret a signal from the toxic gas sensor 160 to determine if an unsafe level of toxic gas is present, and, if so, disengage the ignition of the vehicle engine 102. The system control module 110 can consider the status of the monitored sensors and the toxic gas sensor 160 independently or in combination.

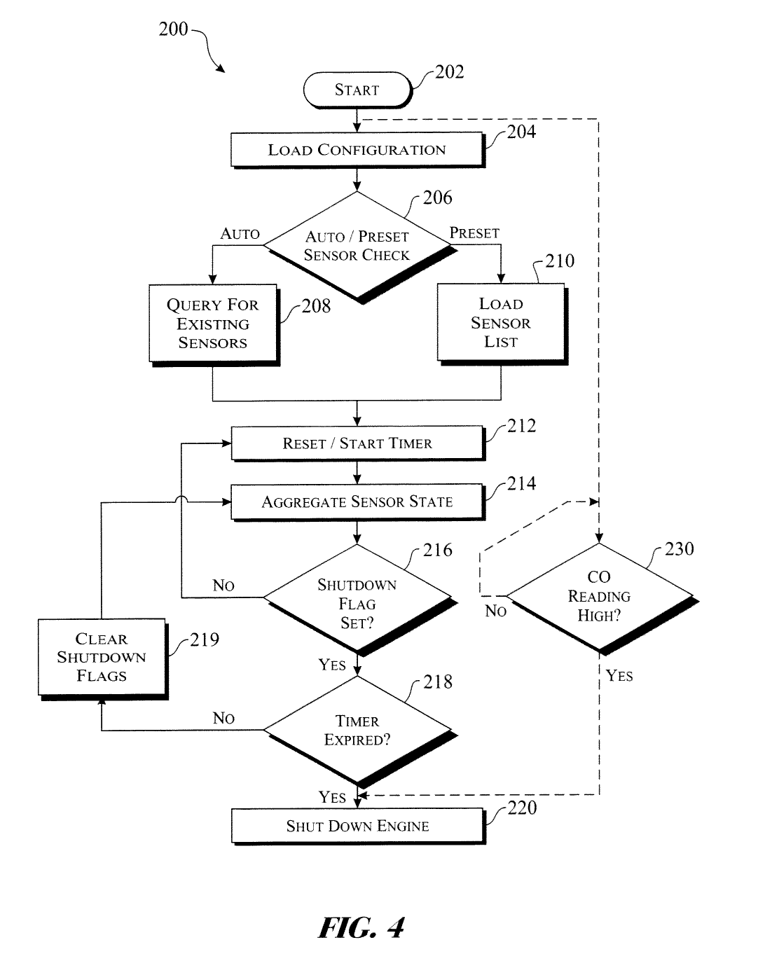

FIG. 4 illustrates an example of a logic-based automatic shutdown overview flow diagram 200 according to the present embodiments. The flow diagram 200 presents a high level operational overview of a process associated with the vehicle status monitor and control system. The flow diagram 200 commences at step 202. The initiated system obtains a test configuration 204, wherein the system loads the test configuration from a source such as a memory (not shown) that is operatively associated with the system control module 110. The test configuration establishes what combination of the status of each sensor determines that the vehicle engine 102 may be producing an accumulation of a toxic gas, such as carbon monoxide, that may become unsafe. The system control module 110 establishes a baseline of each of the monitored sensors in accordance with a sensor check step 206. Sensor data can be obtained by any known means. For example, an automated process may scan all sensors connected to the system control module 110 (step 208). In another example, a predetermined sensor list is used to direct the system control module 110 to scan a specific set of sensors (step 210). The determination is completed by considering both the state of the sensor and a time period in which the sensor remains in the identified state.

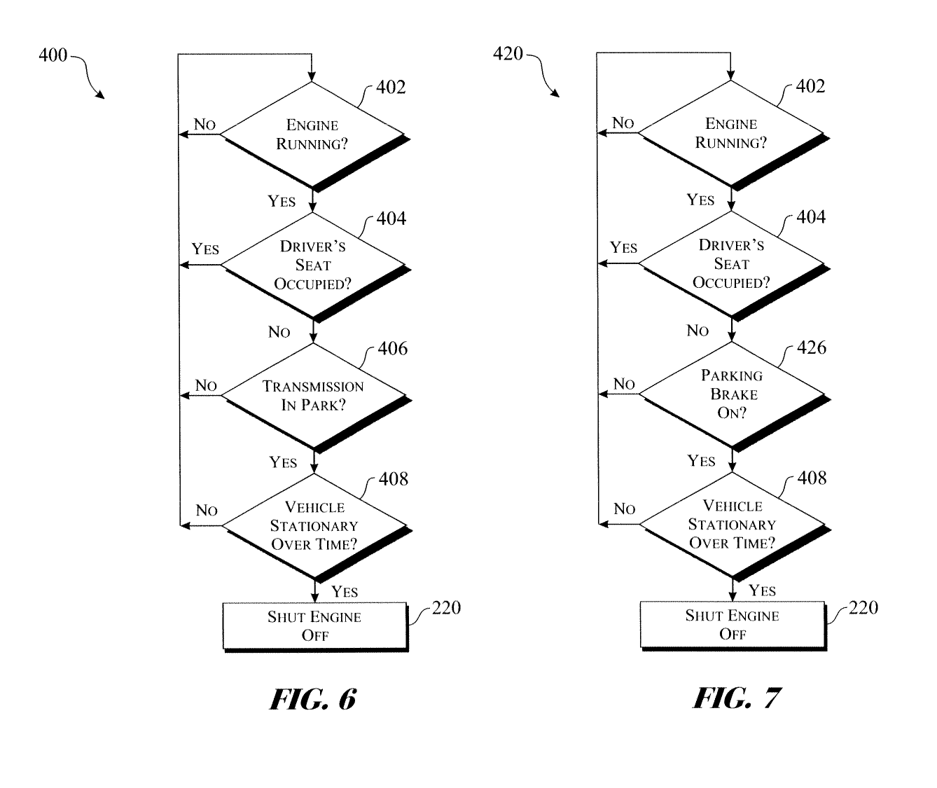

The monitoring process is initiated by resetting and commencing a timer at a start timer step 212. In parallel, the system determines the state of each monitored sensor in accordance with an aggregate sensor state step 214. Details of exemplary sensor decision steps are presented in the sensor state decision flow algorithms 400, 420 illustrated in FIGS. 6 and 7, respectively. The vehicle status monitor and control system reviews the status of each monitored sensor to determine if the sensor state contributes to the final determination that the vehicle 100 is discharging toxic exhaust gases in a stationary location. The vehicle status monitor and control system then uses the timer to determine that the toxic gases are being discharged in a stationary location over a predetermined period of time. One exemplary means of determining both contributors to the final decision is establishing a shutdown flag in the software, referred to as a set shutdown flag step 216, then monitoring a time period until the timer expires (timer expired step 218). Upon expiration of the time period, the process concludes by ceasing operation of the engine (step 220). The step of ceasing operation of the engine can be accomplished by any of a variety of means, including disabling the ignition, terminating any fuel flow. etc. If any of the sensors changes state, the change in state directs the software to reset the shutdown flag, clears the shutdown flags (step 219), and the process returns to the aggregate sensor state step 214.

An optional toxic gas monitoring system can be used in parallel with the status monitoring system described above. The system monitors a data output from the toxic gas sensor 160 for toxic gas levels, such as carbon monoxide, that exceed predetermined acceptable levels (decision step 230). If the toxic gas levels exceed the predetermined acceptable levels, the system verifies that the vehicle is stationary and then ceases operation of the vehicle's engine 102. If the toxic gas levels remain below the predetermined acceptable levels, the toxic gas sensor 160 continues to monitor the environment. Alternatively, the toxic gas sensor 160 can be used as an additional verification data point prior to activating a shutdown process.

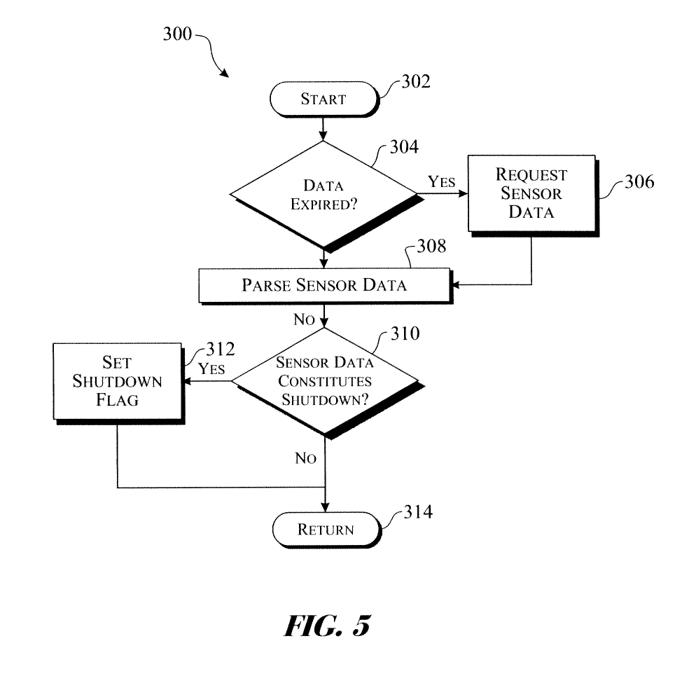

Sensor data management is detailed in an exemplary sensor data management flow process 300 illustrated in FIG. 5. The sensor data management flow process 300 ensures that the decision to shut down the vehicle engine 102 is based upon current data, and commences with a start step 302. The initiated system determines if the data are valid in accordance with a data expired decision step 304. If the sensor data are considered to be expired, the process requests and/or obtains current sensor data 306, ensuring the process decisions are based upon accurate sensor data. If the data are provided in a digital and compiled format, the sensor data are parsed (step 308). At step 310, the process compares the sensor data to the established suggested shutdown state with respect to each sensor. When the process determines that all the sensor(s) indicate a shutdown state, the process establishes a shutdown flag (step 312). The shutdown flag is set only when all monitored sensors agree with the established suggested shutdown state. Contrarily, where at least one sensor fails to meet the established suggested shutdown state, the process returns (step 314) to a monitoring sensors step 304.

The shutdown decision step 310 can be accomplished in any of a variety of ways. Two exemplary sensor state decision flow algorithms 400, 420 are illustrated in FIGS. 6 and 7 respectively. Each of the elements of the system, such as the driver's seat, the speedometer, etc., includes an associated sensor or electrical status indicator to provide an electrical indication representative of the state of the associated element. The sensor or status indicator is in signal communication with the system control module 110 via any means. A common means uses a wiring harness providing a wired, point-to-point connection. Wireless communication may also be used.

The first exemplary sensor state decision flow algorithm 400 determines an engine status, a driver's seat occupancy status, and a vehicle speed. The engine status is determined by monitoring at least one of the engine control unit 104, the ignition system 120, the tachometer 122, etc. The occupancy of the driver's status is determined by monitoring at least one of the driver's seat belt 152, the driver's seat weight sensor 154, a proximity sensor (not shown), etc. The selected transmission gear is determined by monitoring the position of the gearshift lever 130, electronic determination of the selected or engaged gear, etc.

The process determines the state of each of the monitored sensors to determine if conditions exist where toxic gases may accumulate proximate the vehicle and create a potentially hazardous environment. The vehicle status monitor and control system is programmed to monitor and determine if the following conditions exist and are maintained over a predetermined period of time:

a Engine is running (decision step 402);

b. Driver's seat is not occupied (decision step 404); and

c. Vehicle is stationary (decision step 408).

Each of these conditions is established by monitoring and evaluating the status of the respective status indicator(s). The order in which the status of each sensor is obtained and/or reviewed is not critical and can be modified as desired. When the vehicle status monitor and control system determines that all of the monitored status indicators meet the criteria suggesting a potential for the accumulation of toxic exhaust gases, the system initiates a timer. The system determines if the sensors maintain a status within the shutdown criteria over a predetermined period of time (decision step 408). If the status of any of the monitored sensors changes to a status that is excluded from the shutdown criteria during the predetermined time period, the monitoring process is reset and restarted. If the status of all of the monitored sensors remains within the shutdown criteria during the predetermined time period, the process concludes by ceasing operation of the engine (step 220). The use of the transmission setting 406 is one exemplary means of determining the standing state of the vehicle. Any means can be used to determine if the vehicle is stationary.

The sensor state decision flow algorithm 400 of FIG. 6 is advantageously employed with a vehicle having an automatic transmission. The process uses the state of the transmission (step 406) to determine if the vehicle 100 is stationary, which would normally be associated with the transmission being in the “park” state. The sensor state decision flow algorithm 420 of FIG. 7 is advantageously employed with a vehicle having a manual transmission. Since a common practice associated with a manual transmission is to leave the transmission in first gear and apply the parking brake when parked, the process uses the state of the parking brake (step 426) for determining that the vehicle 100 is stationary. Other references besides the transmission 130 and the parking brake 426 can be used to determine if the vehicle is stationary, including the speedometer 124, or any other speed sensor or any other vehicle feature.

The system can be enhanced by monitoring additional status points of the vehicle. Examples are presented in Table 1 presented below. The system control module 110 monitors a predetermined group of sensors. The system compares the status of each monitored vehicle data point status indicator with the decision determination value to determine whether a shutdown flag should be established or the vehicle should remain in an operational state. The system can establish a set of minimum requirements in order to initiate a shutdown process of the vehicle engine 102 or require that all sensors indicate a shutdown condition prior to initiating a shutdown process of the vehicle engine 102.

TABLE 1
Engine Shutdown Sensor Decision Table

| Sensor | | Decision | |
|---|---|---|---|
| No. | Description | Operational | Shutdown |
| 1 | Speedometer | >0 | =0 |
| 2 | Tachometer | Not Idle | Idle |
| 3 | Gear Shift Lever | Not Park | Park Neutral |
| 4 | Parking Brake | Released | Engaged |
| 5 | CO-Sensor | CO | CO Critical |
| 6 | Seat Belt Sensor | Secured | Unsecured |
| 7 | Driver's Seat Weight Sensor | Weighted | No Weight |
| n | nth sensor | Pass | Shutdown |

One example set of minimum requirements includes:

a. Engine is running (decision step 402);

b. Driver's seat is not occupied (decision step 404);

c. Vehicle is stationary (decision step 406); and

d. Vehicle remains stationary over time (decision step 408).

Other sets of minimum requirements can be established that would suggest conditions exist that may create an unsafe accumulation of toxic gases in an enclosed environment.

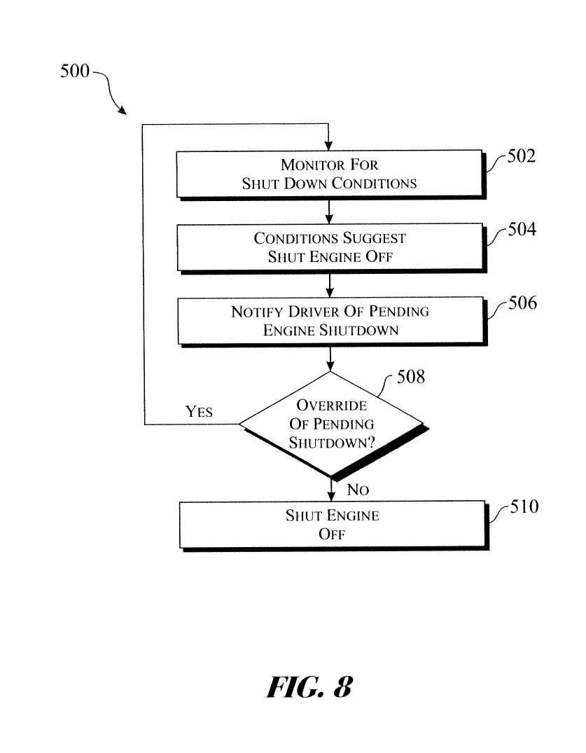

The vehicle status monitor and control system can include a manual override process, such as an exemplary override flow diagram 500 illustrated in FIG. 8. The system monitors (step 502) and determines (step 504) that the conditions are met to initiate the engine shut down process. The vehicle status monitor and control system provides a notification to the driver of a pending engine shutdown (step 506). The notification can be provided within the vehicle, on a remote control (not shown), via a text message or other remote communication, etc. The system can use wireless infrastructure originally integrated into the vehicle. The operator can then tender an override request to the system in accordance with any user interface and communication means, including a switch within the vehicle, a remote signal, a text message, etc. The system monitors for the tendered override request (step 508) over a predetermined override delay time period. If an override is received, the system resets, delays for a predetermined period of time, and subsequently reinitiates the process. If an override is not received within the predetermined override delay time period, the system concludes by ceasing operation of the engine (step 510).

The present embodiments may be directed to vehicles that use an electronic key and a start/stop push button to start and stop the engine. These vehicles use a communication system that interfaces to various system components such as the engine control unit (ECU) 104. Advantageously, the present embodiments do not require that any hardware be added to the vehicle. Certain of the present embodiments can be implemented as an algorithm executed on existing vehicle ECUs. The present embodiments do not need to rely on a specific set or combination of sensors in order to operate properly. The present embodiments address issues of prior approaches, such as sensor failure, by using a generic approach of evaluating sensors. The present embodiments do not need to be “hard coded” to a specific set of sensors. The present embodiments can query a system for available sensors, and then base decision making on only the available inputs. The present embodiments can also recover from sensor failure. Should a sensor become inoperable, it is simply disregarded while the auto shutdown mechanism remains operational using only the remaining sensors. The present embodiments do not require exotic sensors. The present embodiments can be configured to rely only on sensors standard to modern vehicles. Although specialized sensors, such as carbon monoxide sensors, can be evaluated, they are not required in order to determine a shutdown situation.

Part of the algorithm is a generic sensor detection and evaluation process. The algorithm maintains two tables, as shown below. Table 2 contains a list of relevant sensors and their associated values or value ranges that determine a shutdown or no-shutdown condition. Table 3 contains a list of shutdown combinations.

TABLE 2

| Sensor No. | Parameter | Shutdown Value | Operate Value |
|---|---|---|---|
| 1 | Speed | Zero | Not Zero |
| 2 | Tachometer | Idle | Not Idle |
| 3 | Gear Shift | Neutral | Not Neutral |
| . . . | | | |
| N | | | |

TABLE 3

| | S₁ (Speed) | S₂ (Tachometer) | S₃ (Gear Shift) | S_{N} |
|---|---|---|---|---|
| 1 | Shutdown | X | X | X |
| 2 | Operational | X | Shutdown | X |
| 3 | X | Shutdown | Shutdown | X |
| . . . | | | | |
| N | | | | |

Where:

Shutdown=Sensor indicates a shutdown condition:

Operational=Sensor indicates operation; and

X=Sensor data is disregarded.

The above Tables 2 and 3 are simplified and do not account for all the sensors shown in Table 1. The current state of the sensors is compared with the rows in Table 3 above, and if the current state of the sensors matches that of a row in the table a shutdown is justified.

Both Tables 2 and 3 can be modified in order to accommodate new sensors and new sensor parameters. Each sensor that could potentially be relevant for the determination of a shutdown (or no shutdown) is listed in Table 1. This table also contains the value (or value range) that determines the shutdown condition.

While the above description presents several exemplary embodiments of the vehicle status monitor and control system in accordance with this disclosure, and of the manner and process of making and using it, the disclosed subject matter is susceptible to modifications and alternate constructions that are fully equivalent. Consequently, the scope of this disclosure is not limited to the particular embodiments disclosed. On the contrary, this disclosure should be deemed to embrace all modifications and alternate constructions coming within the spirit and scope of thereof, and as defined, for example, by the following claims.

What is claimed is:

1. A vehicle status monitor and control system configured to shutdown an engine of a vehicle when a given set of conditions prevail, the system comprising:
a control module comprising a controller in signal communication with a sensor interface;
a plurality of status sensors in signal communication with the sensor interface;
a time reference in signal communication with the controller; and
an engine control unit in signal communication with the controller and in operational communication with a vehicle's engine ignition system;
wherein the controller operates in accordance with a series of steps directed by a control system software to provide a signal to the engine control unit to disable the vehicle's engine ignition system when a predetermined system status prevails over a predetermined length of time T.

2. The system of claim 1, wherein the plurality of status sensors includes a driver's status sensor operatively associated with a driver's seat in the vehicle and an engine status sensor operatively associated with the engine of the vehicle, and wherein the predetermined system status prevails when the driver's status sensor indicates the driver's seat is empty, and the engine status sensor indicates the engine is operating at an idling speed.

3. The system of claim 2, wherein the driver's status sensor comprises at least one of a weight sensor associated with the driver's seat and a seat belt position sensor associated with the driver's seat.

4. The system of claim 1, wherein the plurality of status sensors includes an engine status sensor operatively associated with the engine of the vehicle and a shift lever status sensor operatively associated with a transmission shift apparatus of the vehicle, and wherein the predetermined system status prevails when the engine status sensor indicates the engine is operating at an idling speed, and the shift lever status sensor indicates the vehicle is in park.

5. The system of claim 1, wherein the plurality of status sensors includes a driver's status sensor operatively associated with a driver's seat in the vehicle, an engine status sensor operatively associated with the engine of the vehicle, and a speedometer status sensor operatively associated with a speedometer in the vehicle, and wherein the predetermined system status prevails when the driver's status sensor indicates the driver's seat is empty, the engine status sensor indicates the engine is running, and the speedometer status sensor indicates that the vehicle is stationary.

6. The system of claim 1, wherein the plurality of status sensors includes an engine status sensor operatively associated with the engine of the vehicle and a parking brake status sensor operatively associated with a parking brake of the vehicle, and wherein the predetermined system status prevails when the engine status sensor indicates the engine is operating at an idling speed, and the parking brake status sensor indicates the parking brake is engaged.

7. The system of claim 1, wherein the plurality of status sensors includes an accelerator status sensor operatively associated with an accelerator control in the vehicle and a parking brake status sensor operatively associated with a parking brake in the vehicle, and wherein the predetermined system status prevails when the accelerator status sensor indicates that the accelerator control is not in an engaged position, and the parking brake status sensor indicates that the parking brake is engaged.

8. The system of claim 1, wherein the plurality of status sensors includes an engine status sensor operatively associated with the engine of the vehicle, an accelerator status sensor operatively associated with an accelerator control in the vehicle, and a shift lever status sensor operatively associated with a transmission shift apparatus in the vehicle, and wherein the predetermined system status prevails when the engine status sensor indicates the engine is operating, the accelerator status sensor indicates that the accelerator control is not in an engaged position, and the shift lever status sensor indicates the vehicle is in park.

9. A vehicle status monitor and control system configured to shutdown an engine of a vehicle when a given set of conditions prevails, the system comprising:
a control module comprising a controller in signal communication with a sensor interface;
a time reference in signal communication with the controller;
a plurality of status sensors in signal communication with the sensor interface; and
an engine control unit in signal communication with the controller and in operational communication with a vehicle's engine ignition system;
wherein the controller operates in accordance with a series of steps directed by a control system software to provide a signal to the engine control unit to disable the vehicle's engine ignition system when one of a plurality of predetermined system statuses prevails for a predetermined length of time, as indicated by a status of each of the plurality of status sensors; and
wherein the controller queries the system for available ones of the sensors, and directs the control system software to disable the vehicle's engine ignition system based upon inputs from only the available ones of the sensors.

10. The system of claim 9, wherein the plurality of status sensors includes at least one of an engine status sensor, a tachometer status sensor, a speedometer status sensor, a parking brake status sensor, a driver's seat status sensor, an accelerator status sensor, a shift lever status sensor, and a transmission status sensor.

11. The system of claim 9, wherein the predetermined system statuses and the predetermined length of time are adjustable.

12. In a motor vehicle equipped with an internal combustion engine and a plurality of status sensors, each of which is indicative of the status of an operational aspect of the vehicle, a method of ensuring that a decision to shut down the engine is based upon current sensor data, the method comprising:
determining if sensor data from the plurality of sensors is current;
if the sensor data is not current, obtaining current sensor data from the plurality of status sensors;
parsing the current sensor data;
comparing the parsed sensor data to an established suggested shutdown state with respect to each one of the plurality of sensors;
determining whether the parsed sensor data corresponds to the suggested shutdown state; and
if the parsed sensor data corresponds to the suggested shutdown state, setting a shutdown flag.

13. The method of claim 12, wherein the plurality of status sensors includes at least one of an engine status sensor, a tachometer status sensor, a speedometer status sensor, a parking brake status sensor, a driver's seat status sensor, an accelerator status sensor, a shift lever status sensor, and a transmission status sensor.

14. The method of claim 13, wherein the driver's seat status sensor comprises at least one of a weight sensor associated with a driver's seat of the vehicle and a seat belt position sensor associated with the driver's seat.
